(19) United States
(12) Patent Application Publication
(10) Pub. No.: US 2009/0324909 A1
(43) Pub. Date: Dec. 31, 2009

(54) Roll with visual cue

(76) Inventors: Michael Alan Hermans, Neenah, WI (US); Simona Michele Hartley, Kingswood (GB); Kanchan Dnyanesh Patkar, Appleton, WI (US); Suzanne Kim Vanderloop, Combined Locks, WI (US)

Correspondence Address: KIMBERLY-CLARK WORLDWIDE, INC.;Tara Pohlkotte, 401 NORTH LAKE STREET, NEENAH, WI, 54956, US

(21) Appl. No.: 12/215,537

(22) Filed: Jun. 27, 2008

(51) Int. Cl. B32B 29/00

(52) U.S. Cl. 428/211.1

(57) ABSTRACT

Bath tissue rolls are provided with indicia or a visual cue representing the number of sheets remaining on the roll so the user better knows in advance when the remaining number of sheets on the roll is getting low.

### BACKGROUND OF THE INVENTION

For bath tissue (toilet paper) users, the concept of “long lasting” is a desirable feature. The inconvenience of changing rolls too often or running out of tissue at an inconvenient time is an issue. Therefore there is a need for a bath tissue product that enables the user to know in advance when the roll is getting low.

### SUMMARY OF THE INVENTION

In one aspect, the invention resides in a roll of bath tissue comprising a plurality of sheets separated by transverse lines of perforation, wherein one or more sheets within the roll contain a visual cue or indicator representing the number of sheets used or remaining on the roll. While the invention is particularly useful for use in association with covered bath tissue dispensers where the roll is not readily visible to the user, it is also beneficial for exposed bath tissue rolls because the remaining number of sheets can be difficult to estimate from either the remaining diameter of the roll or the remaining distance between the outside of the roll and the core.

Consumer studies indicate that under normal usage, from 3 to about 10 sheets of bath tissue may be used at one time, with 6 a typical average. Therefore it can be advantageous to provide a visual cue indicating that at least 10 sheets are remaining on the roll. More particularly, the visual cue can be placed with 20, 30, 40 and/or 50 sheets remaining on the roll. For larger rolls, additional cues might be placed on the roll when a greater number of sheets remain, such as when 100 sheets remain to provide an early clue that a roll change will be required. In this regard, for “double-roll” or “triple-roll” product executions, it can be useful to provide a visual cue representing the equivalent number of sheets for each “roll” within the larger roll. In general, a single roll has about 154 sheets, a double roll has about 308 sheets and a triple roll has about 462 sheets. Therefore, for a double roll product, visual cues can be placed with about the 150 sheets remaining within the roll, indicating the equivalent of a single roll is left. For a triple roll product, visual cues can be placed with about 300 and about 150 sheets remaining within the roll, indicating the equivalent of two rolls and one roll, respectfully, are remaining.

A variety of means can be used to provide the visual cue. In one embodiment, the visual cue can be printed on the face of the sheet. Alternatively, the line of perforation can be modified, such as by providing a notch in the edge of the sheet or other distinctive feature in the perforation. Alternatively, the side of the roll can be marked, such as by providing a color change or change in the texture of the edges of the sheets. Alternatively, a tab could be inserted into the roll at the desired location. In any case, the visual cue is meant to provide the consumer with an indication of the number of sheets remaining on the roll. In this manner, the visual cue is distinguished from other indicia on a tissue sheet, such as aesthetic designs and/or embossments, or indicia meant to provide an indication of the sheet properties or convey some other message to the consumer.

Applying the visual cue can readily be carried out in the converting operations of the bath tissue manufacturing process. Typically, a parent roll of basesheet is unwound and rewound into logs. Lines of perforation are imparted to the basesheet prior to being rewound into the logs. The logs are slit into individual rolls of bath tissue, which are assembled and wrapped in appropriate packages. If the visual cue is to be printed onto the face of the sheets or their edges, this can easily be accomplished by providing a printer or spray applicator downstream of the parent roll unwind location. The visual indicator might be a simple geometric shape or line or more specifically a numeral corresponding to the approximate number of sheets remaining on the roll. Similarly, modification in the perforation lines can be done at the same time by modifying the sequence of the perforation blades. All of these operations can be indexed in accordance with the size of the product roll by methods known to those skilled in the tissue converting arts.

Alternately, the visual cue can be placed on the roll any time after conversion of the logs into individual rolls. For example, a color change indicator might be printed or sprayed on one or both sides of the rolls after conversion from the log into the individual rolls, but prior to packaging the individual rolls, such as wrapping single rolls or combining rolls into larger quantities, such as 4-packs or 8-packs and the like. The packaging or wrapper on the roll or rolls can contain advertising or other information, such as a simple printed message, identifying the presence of a visual cue within the roll or rolls so the consumer knows what to look for.

Alternately, the visual cue can be provided by an operation taking place during the manufacture of the tissue web basesheet on the tissue machine. The visual cue could be placed on the tissue web by a number of means, including the application of a dye, for instance, via spraying a line or other pattern every so many feet of manufactured tissue web length. When the tissue is converted, the visual cue would appear in the finished roll at the aforementioned regular intervals.

Another means of producing a visual cue during manufacturing is the production of a variation in web appearance, such as that made via a dandy roll or induced by a characteristic of one or more of the fabrics, such as a pattern induced by the fabric due to indicia or other variations designed into or placed on the fabric.

Any variation that occurs at a regular interval may be used as an indicator of remaining web length, so long as the converting is done so that the induced indicator in located in the finished roll in a position such that it can serve as an indicator of remaining roll length for the user.

Furthermore, it is possible to combine one or more of the foregoing visual cues in a single roll. For example, a printed indicator might be combined with a notch to give a single visual cue of sheets remaining, or the indicators can be combined to provide a measurement of sheet length remaining as well as another visual cue that indicates a particular property, such as softness.

It will be appreciated that the foregoing description, given for purposes of illustration, is not to be construed as limiting the scope of this invention, which is defined by the following claims and all equivalents thereto.

We claim:

1. A roll of bath tissue comprising a plurality of sheets separated by transverse lines of perforation, wherein one or more sheets within the roll contain a visual cue representing the number of sheets remaining on the roll.

2. The roll of bath tissue of claim 1 wherein the visual cue is printed onto one or more sheets within the roll.

3. The roll of bath tissue of claim 1 wherein the visual cue is a notch in the side of one or more sheets within the roll.

4. The roll of bath tissue of claim 1 where the visual cue is imparted to the side of the roll.

5. The roll of bath tissue of claim 1 wherein the visual cue is a color change on the side of the roll.

6. The roll of bath tissue of claim 1 wherein the visual cue is a sheet color that is different than the other sheets on the roll.

7. The roll of bath tissue of claim 1 wherein the visual cue is a numeral which indicates the number of sheets remaining.

8. The roll of bath tissue of claim 1 wherein the visual cue is provided with from about 10 to about 50 sheets remaining on the roll.

9. The roll of bath tissue of claim 1 wherein the roll contains about 300 sheets and a visual cue is provided with about 150 sheets remaining on the roll.

10. The roll of bath tissue of claim 1 wherein the roll contains about 450 sheets and the visual cue is provided with about 300 sheets remaining on the roll and with about 150 sheets remaining on the roll.

11. The roll of bath tissue of claim 1 wherein the visual cue is incorporated during the tissue basesheet converting process.

12. The roll of bath tissue of claim 1 wherein the visual cue is incorporated during the tissue basesheet manufacturing process.

13. The roll of bath tissue of claim 1 containing two different visual cues.

14. The roll of bath tissue of claim 1, wherein the roll is packaged within a wrapper and the wrapper contains information identifying the presence of a visual cue within the roll.
